(19) United States
(12) Patent Application Publication
(10) Pub. No.: US 2016/0333293 A1
(43) Pub. Date: Nov. 17, 2016

(54) PROCESS TO MANUFACTURE A LIQUID DETERGENT FORMULATION

(71) Applicant: CONOPCO, INC., D/B/A UNILEVER, Englewood Cliffs, NJ (US)

(72) Inventors: Stephen Norman BATCHELOR, Chester (GB); Karen Jane ELLSON, West Kirby (GB); Ian James HUSSEY, Childwall (GB); Mrudula NAGARAJU, Bromborough (GB); Gareth John SAWBRIDGE, Stafford (GB)

(73) Assignee: CONOPCO, INC., D/B/A UNILEVER, Englewood Cliff, NJ (US)

(21) Appl. No.: 15/112,694

(22) PCT Filed: Jan. 21, 2015
(86) PCT No.: PCT/EP2015/051059

§ 371 Date: Jul. 20, 2016

(30) Foreign Application Priority Data
Jan. 22, 2014 (EP) 14152157.5

(51) Int. Cl. C11D 3/40; C11D 1/83; C11D 1/29; C11D 1/66; C11D 17/00; C11D 1/22

(52) U.S. Cl. CPC C11D 3/40; C11D 17/0008; C11D 1/22; C11D 1/29; C11D 1/66; C11D 1/83

(57) ABSTRACT

The present invention relates to a liquid detergent formulation and a process of preparing same comprising the steps of mixing together with stirring for at least 5 minutes in the presence of at least 30 weight % chlorinated water, a surfactant in an amount of 5 to 50 weight %; additional ingredients in an amount of 0 to 20 weight %, at a water temperature of between 18 and 50° C.; followed by the addition of one or more shading dyes.

### TECHNICAL FIELD OF THE INVENTION

The present invention relates to a process of preparing a liquid detergent formulation comprising shading dyes and to a liquid detergent formulation comprising a maximum level of chlorine.

### BACKGROUND OF THE INVENTION

The repeated washing of garments, towels and linens often leads to discolouration or yellowing. This is particularly the case for light or white coloured garments for which yellowing is often clearly apparent leading to a reduction in the aesthetic appeal of for example, garments, towels or sheets.

In order to overcome discolouration and maintain the original appearance of a light coloured article, white appearance shading dyes may be used as part of a detergent formulation. The shading dyes are fabric substantive and are employed as part of a main wash of the garment and are preferably blue or violet dyes classified as: acid dyes, direct dyes or hydrolysed reactive dyes. The use of shading dyes in powder formulations and liquid formulations is known. For example, EP 2227534 discloses a laundry treatment composition comprising a surfactant, fluorescent agent and DANSA dye.

Unfortunately, when using such shading dyes in liquid detergent formulations, the process of preparing the liquid detergent may lead to a breakdown of the shading dye, or discolouration of the shading dye per se, with concomitant reduced performance of the liquid detergent formulation and hence the increased yellowing of garments washed with said formulations. This is especially true when the liquid detergent formulations are prepared on a large scale using chlorinated water as the batch water.

In an attempt to overcome this problem the inventors have now found that it is possible to prepare liquid detergent formulations in which the shading dyes do not breakdown, and are not bleached by chlorinated batch water, but which are still able to meet the demands of vigorous wash cycles whilst avoiding the troublesome problem of yellowing of garments and linens.

### OBJECT OF THE INVENTION

It is therefore an object of the present invention to provide an improved process of preparing a liquid detergent formulation which seeks to overcome one or more of the aforementioned disadvantages of known processes and/or to provide one or more of the aforementioned benefits.

### STATEMENT OF THE INVENTION

Therefore, according to a first aspect of the present invention there is provided a process of preparing a liquid detergent formulation comprising the steps of:
(i) mixing together with stirring for at least 5 minutes in the presence of at least 30 weight % chlorinated water,
   a surfactant in an amount of 5 to 50 weight %; and
   additional ingredients in an amount of 0 to 20 weight %,
   at a water temperature of between 18 and 50° C.;
followed by,
(ii) the addition of one or more shading dyes.

It is preferred that in the process of preparing a liquid detergent formulation according to the present invention the chlorinated water comprises 0.2 to 10 ppm chlorine. More preferably the chlorinated water comprises 1 to 5 ppm. Most preferably the chlorinated water comprises 1.5 to 4.5 ppm chlorine. Even more preferably the chlorinated water comprises 1.5 to 4.0 ppm chlorine

Also in relation to the process of preparing a liquid detergent formulation according to the present invention, the chlorinated water, surfactant and additional ingredients may be mixed together at a water temperature of between 18 and 50° C. to form a homogenous mixture.

In the process according to the present invention in which the chlorinated water, surfactant and additional ingredients are preferably mixed together to form a homogenous mixture, it will be appreciated by one skilled in the art that the time to achieve a homogenous mixture may vary depending upon nature of the surfactant and additional ingredients as well as the temperature of the surrounding. However, it is expected that at a temperature of between 18° C. and 50° C. the time taken to achieve a homogenous mixture may be between 5 and 200 minutes. More preferably at a temperature of between 20° C. and 45° C. the time taken to achieve a homogenous mixture may be between 10 and 150 minutes. Even more preferably however, at a temperature of between 25° C. and 40° C. the time taken to achieve a homogenous mixture may be between 20 and 120 minutes.

As stated above, in relation to the process of preparing a liquid detergent formulation according to the present invention, the surfactant may be present in an amount of 5 to 50 weight % in the final formulation. More preferably, the surfactant may be present in an amount of 8 to 40 weight % in the final formulation. Most preferably, the surfactant may be present in an amount of 10 to 30 weight % in the final formulation.

Also in relation to the process of preparing a liquid detergent formulation according to the present invention, it may be required to add one or more ingredients selected from the group consisting of:
antimicrobial agents, fluorescers, fragrances, hydrotopes, sequestrants, perfume oils, enzymes and polymers, to the surfactant and chlorinated water with mixing, prior to the addition of the one or more shading dyes. This may increase or decrease the time taken to achieve a homogenous mixture of ingredients for the detergent formulation, however, it is preferred that these ingredients are added to the surfactant and chlorinated water with mixing prior to the addition of one or more shading dyes, with mixing to form a homogenous mixture. In addition, one or more non-shading dyes are preferably added after the surfactant. Most preferably one or more non-shading dyes are added with the one or more shading dye.

When forming the liquid detergent formulation using the process of the present invention it is possible to add one or more shading dyes to the chlorinated water and surfactant. The one or more shading dyes may be added to the chlorinated water and surfactant at a concentration of 0.0001 to 0.5 weight % in the final formulation. More preferably the one or more shading dyes may be added to the chlorinated water and surfactant at a concentration of 0.0005 to 0.05 weight %. Most preferably however, the one or more shading dyes are added to the chlorinated water and surfactant at a concentration of 0.001 to 0.1 weight %. The one or more shading dyes may be added as a solid or as an aqueous solution or slurry. Preferably however, the one or more shading dyes are added to the formulation as an aqueous solution or slurry. Preferably the aqueous solution or slurry comprises 0.1 to 5 weight % shading dye. Most preferably the aqueous solution or slurry comprises 0.5 to 2 weight % shading dye. Even more preferably the aqueous solution or slurry comprises at least 1 weight % shading dye.

In addition, in the process of preparing a liquid detergent formulation according to the present invention the one or more shading dyes are selected from the group consisting of:
direct dyes, acid dyes, hydrophobic dyes, cationic dyes, reactive dyes, dyes comprising one or more carboxylic acid groups, and azo dyes comprising one or more carboxylic acid groups.

If required, two or more shading dyes may be added to the mixture of chlorinated water and surfactant to provide the required visual hue to fabric washed with the liquid detergent formulation. In which case, the two or more shading dyes may be blended to form an aqueous solution prior to addition to the chlorinated water and surfactant.

When the liquid detergent formulation comprises two or more shading dyes, the two shading dyes may be selected from the group consisting of: azo dyes, azine dyes or triphenylmethane dyes.

Also in relation to the process of preparing a liquid detergent formulation according to the present invention, the surfactants may be selected from the group consisting of group consisting of:
linear alkyl benzene sulfonates, linear and branched alkyl sulfonates, alkyl ethoxylates, linear and branched alklyl ether sulfates.

The liquid detergent formulation once prepared may be transferred to a container for either: storage, shipping or sale.

According to a second aspect of the present invention there is provided a liquid detergent formulation which may be prepared according to the first aspect of the present invention comprising:
a) at least 30 weight % chlorinated water;
b) at least 5 to 50 weight % surfactant;
c) additional ingredients in an amount of 0 to 20 weight %; and
d) at least 0.0001 to 0.5 weight % shading dye, and
   wherein the formulation comprises 0.2 to 10 ppm chlorine.

It will be appreciated by one skilled in the art that in the process of the present invention the two or more shading dyes may be blended together to form an aqueous solution or slurry in water prior to addition to the chlorinated water and surfactant, or the two or more shading dyes may be added as solid particles to the chlorinated water and surfactant. However, it is most preferred that the two or more shading dyes are blended together to form an aqueous solution in water prior to addition to the chlorinated water and surfactant. Blending of the two or more shading dyes is preferably achieved with or without milling the dyes together in water followed by stirring at a temperature of between 50° C. and 90° C. for 5 to 60 minutes. Most preferably, blending of the two or more shading dyes is achieved by mixing the dyes together in water followed by stirring at a temperature of between 75° C. and 85° C. for 5 to 60 minutes.

### DETAILED DESCRIPTION OF THE INVENTION

### Shading Dyes

Shading dyes deposit to fabric during a wash or rinse step of the washing process providing a visible hue to the fabric.

Examples of Shading dyes suitable for use in accordance with the present invention and incorporated herein by reference are detailed in: WO2005/003274, WO2006/032327(Unilever), WO2006/032397(Unilever), WO2006/045275(Unilever), WO 2006/027086(Unilever), WO2008/017570(Unilever), WO2008/141880(Unilever), WO2009/132870(Unilever), WO2009/141173 (Unilever), WO2010/099997(Unilever), WO 2010/102861(Unilever), WO2010/148624(Unilever), WO2012/119859 (Unilever), WO2008/087497 (Proctor & Gamble) and WO2011/011799 (Proctor & Gamble), WO 2012/054058(Proctor & Gamble), WO 2012/054835 (Proctor & Gamble), WO 2012/166768 (Proctor & Gamble), WO2013/142495 (Proctor & Gamble) and WO2013/151970 (Proctor & Gamble).

The shading of white garments may be done with any colour depending on consumer preference. Blue and violet shading are particularly preferred shades by consumers and consequently preferred dyes or mixtures of dyes are ones that provide a blue or violet shade on white fabrics. The shading dyes used in the present invention are also preferably blue or violet. A mixture of shading dyes may be used and indeed are often preferred when treating mixed fibre textiles. In this regard, preferred dyes provide a blue or violet colour to a white cloth with a hue angle of 240 to 345°. More preferably preferred dyes provide a blue or violet colour to a white cloth with a hue angle of 260 to 320°. Most preferably however, preferred dyes provide a blue or violet colour to a white cloth with a hue angle of 270 to 300°. A white cloth is used to perform shading tests which is bleached and comprises non-mercerised woven cotton sheeting.

Preferably the shading dye solution should be prepared at a temperature of 80° C. and used within 10 minutes of preparation.

However, in relation to the process according to the present invention is it essential that the shading dyes are added after the addition of surfactant. Addition of the shading dyes to the liquid formulation after the addition of surfactant has the benefit of minimising the exposure of the shading dyes to chlorine in the chlorinated water.

The shading dye chromophore may be selected from the group comprising: mono-azo, bis-azo, triphenylmethane, triphenodioxazine, phthalocyanin, naptholactam, azine and anthraquinone. Most preferably, the shading dye chromophore is selected from the group consisting of mono-azo, bis-azo, azine and anthraquinone.

It is also preferred that the shading dye is alkoxylated. More preferably, the shading dye is ethoxylated. Most preferably however, the shading is ethoxylated and comprises at least one alkoxy chain with from 2 to 8 repeating units.

In addition, the dye is preferably uncharged or negatively charged in aqueous solution at a pH of 7.

Many examples of shading dyes are found in the classes of basic, solvent, acid, direct and disperse dyes.

It is preferred that the shading dyes utilized in the present invention are selected from the group consisting of: direct dyes, acid dyes, hydrophobic dyes, cationic dyes and reactive dyes, dyes bearing carboxylic acid groups and azo dyes bearing carboxylic acid groups. It is more preferred that shading dyes which are azo dyes and which bear carboxylic acid groups are used.

It is also preferred that the shading dye in the detergent formulation according to the present comprises from 0.0001 to 0.1 weight % of the formulation. However, it will be appreciated by a skilled reader that for each shading dye there is a preferred range depending upon the efficacy of the shading dye, which is dependent on the class and particular efficacy within any particular class. As stated above the shading dye is most preferably a blue or violet shading dye.

### Direct Dyes

In relation to the present invention, direct violet and direct blue dyes are preferred for use. In addition, the dye is also preferably a bis-azo dye. Most preferably, the direct dye is a direct violet dye of the following structures:

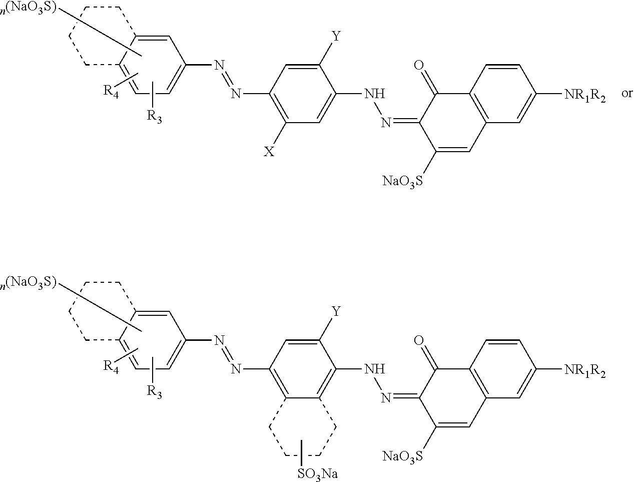

wherein:
the ring bearing R₃ and R₄ may be independently naphthyl or phenyl as shown;
R₁ is hydrogen or C₁-C₄-alkyl, preferably hydrogen;
R₂ is hydrogen, C₁-C₄-alkyl, substituted or unsubstituted phenyl and substituted or unsubstituted naphthyl, preferably phenyl;
R₃ and R₄ are each independently selected from: hydrogen, a polyalkoxy group linked to a ring via a SO₂NH group, and C₁-C₄-alkyl, preferably hydrogen or methyl;
X and Y are each independently selected from: hydrogen, C₁-C₄-alkyl and C₁-C₄-alkoxy; preferably the dye has X=methyl; and, Y=methoxy and n is 0, 1 or 2, preferably 1 or 2.

Preferred dyes are selected from the group consisting of: direct violet 7, direct violet 9, direct violet 11, direct violet 26, direct violet 31, direct violet 35, direct violet 40, direct violet 41, direct violet 51, and direct violet 99, and bis-azo copper containing dyes such as direct violet 66 may also be used.

Sulphonated, alkoxylated bis-azo dyes as described in WO2012/054058 are also preferred.

However, benzidene based dyes are not preferred.

Preferably the direct dye is present in the formulation at a concentration of 0.00001 weight % to 0.0010 weight %.

In another embodiment the direct dye may be covalently linked to photo-bleach, as described for example in WO2006/024612 and WO2010/099997, the details in relation to which are incorporated herein by reference.

### Acid Dyes

Cotton substantive acid dyes give benefits to cotton containing garments. Preferred dyes and mixes of dyes are blue or violet. Preferred acid dyes which may be used in accordance with the present invention are:

(i) azine dyes, wherein the dye comprises the following core structure:

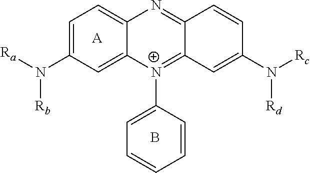

wherein Rₐ, R_{b}, R_{c} and R_{d} are each independently selected from: H, a branched or linear C₁ to C₇-alkyl chain, benzyl, phenyl, and naphthyl;
the dye is substituted with at least one SO₃⁻ or COO⁻ group;
ring B does not carry a negatively charged group or salt thereof; and
ring A may be further substituted to form naphthyl;
the dye may also be optionally substituted by groups selected from the groups consisting of: amine, methyl, ethyl, hydroxyl, methoxy, ethoxy, phenoxy, Cl, Br, I, F, and NO₂.

Preferred azine dyes for use in the present invention include: acid blue 98, acid violet 50, and acid blue 59 and dye with CAS-Number 72749-80-5. Preferred non-azine acid dyes include: acid violet 17, acid black 1 and acid blue 29.

Preferably the acid dye is present in the detergent formulation according to the present invention at 0.0005 weight % to 0.01 weight %.

### Hydrophobic Dyes

Hydrophobic dyes are dyes which do not contain any charged water solubilising group. Hydrophobic dyes may be selected from the groups consisting of: disperse and solvent dyes.

The detergent formulation according to the present invention may therefore comprise one or more hydrophobic dyes selected from the group consisting of: benzodifuranes, methine, triphenylmethanes, napthalimides, pyrazole, napthoquinone, anthraquinone and mono-azo or di-azo dye chromophores.

Blue and violet anthraquinone and mono-azo dye chromophores are preferred. Preferred hydrophobic dyes are selected from the group consisting of: solvent violet 13, disperse violet 27 disperse violet 26, disperse violet 28, disperse violet 63 and disperse violet 77.

The hydrophobic dye may also preferably be an alkoxylated dye. Most preferably the hydrophobic may be an alkoxylated mono-azo thiophene dye.

Preferably the hydrophobic dye is present in the formulation at 0.0001 weight % to 0.01 weight %.

### Cationic Dyes

Cationic dyes are dyes which possess a cationic charge. Preferred cationic dyes used in accordance with the present invention are selected from the group consisting of: mono-azo, phenazines, triphenyl methane and anthraquinone dyes. However, cationic mono-azo dye and phenazine dyes are most preferred when used in accordance with the present invention.

To avoid hydrolysis for mono-azo and anthraquinone dyes, preferably the cationic charge is present as a quaternary amine on a pendant chain. The cationic dyes may be alkoxylated; and mono-azo dyes may additionally possess anionically charged groups, preferably also on pendant chains. Mono-azo dyes containing a heterocyclic ring are particularly preferred, such as thiophenes and preferred cationic phenazine dyes are of the form:

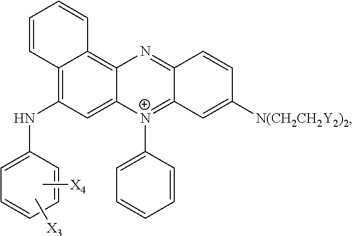

wherein:
X₃ is selected from: —H, —F, —CH₃, —C₂H₅, —OCH₃, and —OC₂H₅;
X₄ is selected from: —H, —CH₃, —C₂H₅, —OCH₃, and —OC₂H₅; and
Y₂ is selected from: —OH, —OCH₂CH₂OH, —CH(OH)CH₂OH, —OC(O)CH₃, and, C(O)OCH₃.

### Reactive Dyes

Reactive dyes are dyes which contain an organic group and which are capable of reacting with an aliphatic C—OH, C—NH2 or C—NH—C group to form a covalent bond. Reactive dyes deposit onto cotton.

Preferably the reactive group in the dye is hydrolysed, or alternatively, the reactive group is reacted with an organic species such as for example, a polymer, in order to link the dye to the organic species. Reactive dyes may be selected from the groups consisting of: reactive violet and reactive blue dyes listed in the Colour Index International.

Preferably the reactive dye is reacted with a polymer containing either NH2 or NH groups, most preferably a partially alkoxylated polyethylene imine polymer.

It will be appreciated by one skilled in the art that in the process of the present invention that two or more shading dyes may be blended together to form an aqueous solution in water prior to addition to the chlorinated water and surfactant or the two or more shading dyes may be added as solid particles to the chlorinated water and surfactant. However, it is most preferred that the two or more shading dyes are blended together to form an aqueous solution in water prior to addition to the chlorinated water and surfactant. Blending of the two or more shading dyes is achieved by mixing or milling the dyes together in water followed by stirring at a temperature of between 65° C. and 90° C. for 1 to 65 minutes. Most preferably, blending of the two or more shading dyes is achieved by milling or mixing the dyes together in water followed by stirring at a temperature of between 75° C. and 85° C. for 1 to 10 minutes.

Further examples of shading dyes include:

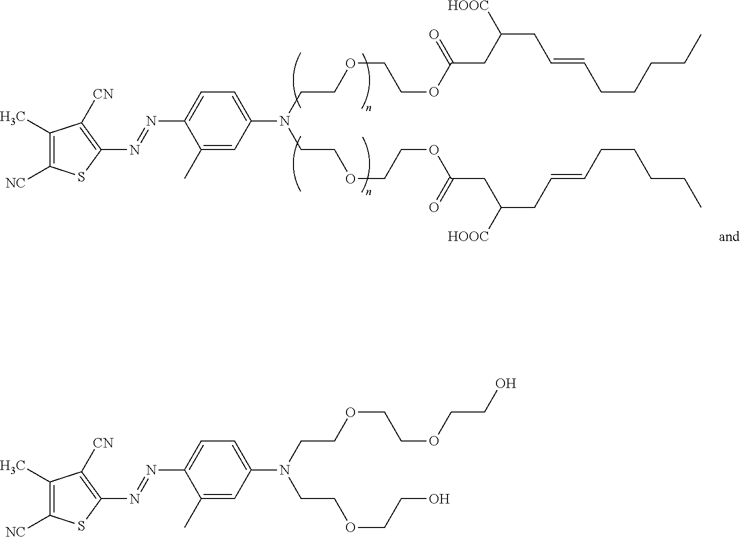

### Surfactants

The formulation prepared by the method of the present invention preferably comprises between 5 to 50 weight % of a surfactant. Most preferably the formulation prepared by the method of the present invention preferably comprises between 10 to 30 weight %.

In general, nonionic and anionic surfactants may be chosen from the surfactants described in “Surface Active Agents” Vol. 1, by Schwartz & Perry, lnterscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Mixtures of synthetic anionic and nonionic surfactants, or a wholly anionic mixed surfactant system or admixtures of anionic surfactants, nonionic surfactants and amphoteric or zwitterionic surfactants may all be used according to the choice of the formulator for the required cleaning duty and the required dose of the detergent formulation.

Anionic surfactants may also further include soap (that is, a salt of fatty acid). A preferred soap employed in detergent formulations according to the present invention is made by neutralisation of hydrogenated coconut fatty acid, for example Prifac® 5908 (ex Croda). Mixtures of saturated and unsaturated fatty acids may also be used.

Nonionic detergent surfactants are well-known in the art. A preferred nonionic surfactant is a C₁₂-C₁₈ ethoxylated alcohol, comprising 3 to 9 ethylene oxide units per molecule. More preferred are C₁₂-C₁₅ primary, linear ethoxylated alcohols with on average between 5 and 9 ethylene oxide groups. More preferably, linear ethoxylated alcohols with an average of 7 ethylene oxide groups are employed.

Examples of suitable synthetic anionic surfactants include: sodium lauryl sulphate, sodium lauryl ether sulphate, ammonium lauryl sulphosuccinate, ammonium lauryl sulphate, ammonium lauryl ether sulphate, sodium cocoyl isethionate, sodium lauroyl isethionate, and sodium N-lauryl sarcosinate. Mostly preferably, the synthetic anionic surfactants comprise synthetic anionic surfactant linear alkylbenzene sulphonate (LAS) or another synthetic anionic surfactant sodium alcohol ethoxy-ether sulphate (SAES), most preferably comprising high levels of sodium C₁₂ alcohol ethoxy-ether sulphate (SLES). It is preferred for the detergent composition according to the present invention to comprise linear alkylbenzene sulphonate LAS.

A preferred mixed surfactant system comprises synthetic anionic with nonionic detergent active materials and optionally amphoteric surfactant, including amine oxide.

Another preferred mixed surfactant system comprises two different anionic surfactants, preferably linear alkyl benzene sulphonate and a sulphate, for example LAS and SLES.

Synthetic anionic surfactants may be present, for example, in amounts in the range from about 5% to about 70 weight % of the mixed surfactant system.

The detergent compositions may further comprise an amphoteric surfactant, wherein the amphoteric surfactant is present in a concentration of 1 to 20 weight %. Preferably the detergent compositions comprise an amphoteric surfactant present in a concentration of 2 to 15 weight %. More preferably the detergent compositions comprise an amphoteric surfactant present in a concentration of 3 to 12 weight % of the mixed surfactant system. Typical examples of suitable amphoteric and zwitterionic surfactants include: alkyl betaines, alkylamido betaines, amine oxides, aminopropionates, aminoglycinates, amphoteric imidazolinium compounds, alkyldimethylbetaines or alkyldipolyethoxybetaines.

In another aspect which is also preferred the surfactant may be cationic such that the formulation is a fabric conditioner.

### Chlorine Levels

Chlorine levels are preferably measured using the (diethylparaphenylene diamine) indicator test, using a comparator as described by the World Health Organisation (How to measure chlorine residuals, WHO-Technical Notes for Emergencies, Technical Note No. 11). The method is further described in ISO 7393-2:1985 Water quality—Determination of free chlorine and total chlorine—Part 2: Colorimetric method using N,N-diethyl-1,4-phenylenediamine, for routine control purposes.

Chlorine levels refer to free chlorine.

### Fluorescent Agents

The detergent formulation according to the present invention may also preferably comprise a fluorescent agent (optical brightener). Fluorescent agents are well known and many such fluorescent agents are available commercially. Usually, these fluorescent agents are supplied and used in the form of alkali metal salts, for example, as sodium salts. The total amount of the fluorescent agent or agents used in the composition is generally from 0.005 to 2 weight %. More preferably 0.01 to 0.1 weight %.

### Perfumes

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

### Optional Ingredients

The compositions may also contain one or more optional ingredients conventionally included in liquid detergent formulations such as but not limited to: polymeric thickeners; enzymes, particularly: lipase, cellulase, protease, mannanase, amylase and pectate lyase; cleaning polymers, including ethoxylated polyethylene imines (EPEI) and polyester soil release polymers; chelating agents or sequestrants, including HEDP (1-Hydroxyethylidene-1,1,-diphosphonic acid) which is available, for example, as Dequest® 2010 from Thermphos; detergency builders; hydrotropes; neutralising and pH adjusting agents; optical brighteners; antioxidants and other preservatives, such as antimicrobial agents including Proxel®; other active ingredients, processing aids, dyes or pigments, carriers, fragrances, suds suppressors or suds boosters, chelating agents, clay soil removal/anti-redeposition agents, fabric softeners, dye transfer inhibition agents, and transition metal catalyst in a composition substantially devoid of peroxygen species.

These and further possible ingredients for inclusion in the present invention are further described in WO 2009/153184 and are incorporated herein by reference.

### Packaging

The liquid detergent formulation of the present invention may be packaged in any form of container. Typically a plastic bottle with a detachable closure/pouring spout. The bottle may be rigid or deformable. A deformable bottle allows the bottle to be squeezed to aid dispensing. If clear bottles are used they may be formed from PET. Polyethylene or clarified polypropylene may also be used. Preferably the container is clear enough that the liquid, with any visual cues therein, is visible from the outside. The bottle may be provided with one or more labels, or with a shrink wrap sleeve which is desirably at least partially transparent. For example an area of 50% of the sleeve may be transparent. Adhesives used to secure any transparent label should however, not adversely affect the transparency.

### EXPERIMENTAL SECTION

The invention will now be further described with reference to the following non-limiting examples and accompanying drawings in which:

FIG. 1—is an absorbance spectrum illustrating the change in absorbance for two shading dyes in a liquid detergent formulation prepared by a standard route and by the process of the present invention.

### ABBREVIATIONS

The following abbreviated names used in these examples have the following meanings:
MPG is Monopropylene Glycol (hydrotrope).
NaOH is 47% sodium hydroxide base.
LAS acid is linear alkyl benzene sulphonic acid anionic surfactant.
SLES(3EO) is SLES 3EO anionic surfactant.
Preservative is Proxel GXL™ antimicrobial preservative, 20% solution of 1,2 benzisothiazolin-3-one in dipropylene glycol and water ex Arch Chemicals.
Perfume is free oil perfume.
Kleen is an encapsulated fragrance.

### Experimental

The following examples illustrate a method of preparing a liquid laundry treatment composition in accordance with the present invention and a comparative method of preparing a liquid laundry treatment composition.

Examples of the invention are denoted by a number and comparative examples are denoted by a letter. Unless otherwise specified, the amounts and proportions used in the method and compositions are by weight.

### Examples

The liquid detergent formulation listed in Table 1 was prepared by mixing the ingredients listed therein using two procedures. The first procedure known as route A is a standard procedure for preparing a liquid detergent composition. The second procedure referred to a route 1, follows the procedure according to the present invention.

TABLE 1

| INGREDIENTS IN LIQUID DETERGENT | |
|---|---|
| FORMULATION | WEIGHT % |
| Linear alkyl benzene sulfonic acid | 8.4 |
| Alcohol ethoxylate (C₁₂-C₁₅ primary alcohol | 2.1 |
| with 7 moles of ethoxylate (EO)) | |
| Sodium lauryl ether sulphate (3EO) | 10.5 |
| 1,2-propanediol | 2.0 |
| Sodium chloride | 0.5 |
| Fragrance | 0.26 |
| Citric acid | 0.5 |
| Sodium hydroxide | 1.22 |
| Triethanolamine | 1.5 |
| Fluorescer | 0.1 |
| Antimicrobial agent (Proxel ™ GXL) | 0.02 |
| Non-shading dye | 0.001 |
| Water | remainder |

### Preparation of Shading Dye Mixture

Prior to preparation of the liquid laundry formulation, a shading dye mixture was prepared by dissolving one or more shading dyes in chlorinated water at 80° C. to obtain a mixture comprising 1 weight % of dye. Preferably the shading dyes were completely dissolved in the chlorinated water. The shading dyes used have CAS-Number 72749-80-5 and CAS-Number 6227-14-1.

The shading dye mixture was added to the liquid detergent formulation at a concentration to achieve an optical absorbance of 0.55 at 577 nm using a 1 cm cell. The optical absorbance is therefore proportional to the shading dye concentration.

In both procedures described below, chlorinated water was used which contained 4 ppm chlorine, and the formulation was prepared on a 1 kg scale, by the two routes. All mixing steps were performed at room temperature.

### Route A: Standard Procedure

The chlorinated water was first placed into a mixing vessel at room temperature. The shading dye mixture was then added to the chlorinated water and components stirred for 2 minutes. The remaining formulation ingredients listed in the Table 1 where then added to the chlorinated water and shading dye mixture.

### Route 1—Procedure According to the Present Invention

As with the standard route ‘A’ procedure described above, chlorinated water was first placed in a mixing vessel at room temperature. The formulation ingredients listed in Table 1 were then added to the chlorinated water and the resultant mixture stirred for 40 minutes ensuring dispersion of all ingredients. The shading dye mixture described above was then added to the detergent formulation with mixing for 1 minute.

The optical absorbance of the liquid detergent formulations prepared using Route ‘A’ and Route 1 was then measured at 577 nm and the results are illustrated in Table 2.

TABLE 2
Optical Absorbance measurements for the liquid detergent formulations
prepared by Route ‘A’ and Route 1

| | OPTICAL ABSORBANCE MEASUREMENT AT |
|---|---|
| | 577 nm |
| Route ‘A’ | 0.20 |
| Route 1 | 0.54 |
| Colour standard | 0.55 |

As may be seen from the optical absorbance measurements recorded in Table 2, the preparation of a liquid detergent formulation using Route ‘A’ leads to a reduced optical absorbance at 577 nm, which is indicative of a reduction in the amount of shading dye, compared to the optical absorbance measurement recorded for the liquid detergent formulation prepared by Route 1, which retains substantially all of the shading dye.

That is, the intensity of the absorbance measured for a formulation with a shading dye added at the start of the formulation process is reduced compared with the intensity of the absorbance for a formulation prepared using the process of the present invention, (that is Route 1), in which the shading dye is added after the addition of the other ingredients in the formulation.

### SUMMARY

Therefore, whilst not wishing to be bound by any particular theory, it may be seen that in accordance with the process of the present invention, shading dyes or shading dye mixtures may be added as a blend during the preparation of a liquid detergent formulation with minimal impact on the colour intensity of the shading dye in the final liquid detergent formulation.

Furthermore, also in accordance with the process of the present invention, shading dyes or shading dye mixtures may be added as a blend during the preparation of a liquid detergent formulation with minimal impact on the colour intensity of the final liquid detergent formulation even when the liquid detergent formulation is prepared using chlorinated water comprising 4 ppm chlorine.

However, in line with the process of the present invention it is also most preferred that the shading dye or shading dye mixture is the last ingredient added to the liquid detergent formulation.

1. A process of preparing a liquid laundry detergent formulation comprising the steps of:
(i) mixing together with stirring for at least 5 minutes in the presence of at least 30 weight % chlorinated water,
a surfactant in an amount of 5 to 50 weight %; and
additional ingredients in an amount of 0 to 20 weight %,
at a water temperature of between 18 and 50° C.;
followed by,
(ii) the addition of one or more shading dyes, and
wherein the chlorinated water comprises 0.2 to 10 ppm chlorine.

2. The process of preparing a liquid laundry detergent formulation according to claim 1 wherein the chlorinated water comprises 1.5 to 4.5 ppm chlorine.

3. A process of preparing a liquid laundry detergent formulation according to claim 1 or 2 wherein the chlorinated water, surfactant and additional ingredients are mixed together at a water temperature of between 20 and 45° C. to form a homogenous mixture.

4. A process of preparing a liquid laundry detergent formulation according to any preceding claim wherein the additional ingredients are selected from the group consisting of:
antimicrobial agents, fluorescers, fragrances, hydrotopes, sequestrants, perfume oils, enzymes, and are each added to the surfactant and chlorinated water with mixing, prior to the addition of the one or more shading dyes.

5. A processing of preparing a liquid laundry detergent formulation according to any preceding claim wherein the one or more shading dyes are added to the chlorinated water and surfactant as a solid or in aqueous solution, at a concentration of 0.0001 to 0.5 weight %.

6. A process of preparing a liquid laundry detergent formulation according to any preceding claim wherein the one or more shading dyes are selected from the group consisting of:
direct dyes, acid dyes, hydrophobic dyes, cationic dyes, reactive dyes, dyes comprising one or more carboxylic acid groups, and azo dyes comprising one or more carboxylic acid groups.

7. A process of preparing a liquid laundry detergent formulation according to any preceding claim wherein two shading dyes are added to the mixture of chlorinated water and surfactant.

8. A process of preparing a liquid laundry detergent formulation according to claim 7 wherein the two shading dyes are blended to form an aqueous solution prior to addition to the chlorinated water and surfactant.

9. A process of preparing a liquid laundry detergent formulation according to claim 7 or 8 where the two shading dyes are selected from the group consisting of: azo dyes, azine dyes or triphenylmethane dyes.

10. A process of preparing a liquid laundry detergent formulation according to any preceding claim wherein the surfactants are selected from the group consisting of group consisting of:
linear alkyl benzene sulfonates, linear and branched alkyl sulfonates, alkyl ethoxylates, linear and branched alkyl ether sulfates.

11. A process of preparing a liquid laundry detergent formulation according to any preceding claim wherein the chlorinated water used to prepare the formulation comprises 1 to 4 ppm chlorine.

12. A liquid laundry detergent formulation prepared according to any of claims 1 to 11 in a container.

13. A liquid laundry detergent formulation comprising:
a) at least 30 weight % chlorinated water;
b) at least 5 to 50 weight % surfactant;
c) additional ingredients in an amount of 0 to 20 weight %; and
d) at least 0.0001 to 0.5 weight % shading dye, and
wherein the formulation comprises 0.2 to 10 ppm chlorine.

14. The liquid laundry detergent formulation according to claim 12 or claim 13 wherein the chlorinated water comprises 1.5 to 4.5 ppm chlorine.
